(19) United States
(12) Patent Application Publication
(10) Pub. No.: US 2010/0290972 A1
(43) Pub. Date: Nov. 18, 2010

(54) PROCESS AND DEVICE FOR THE PRODUCTION OF HIGH-PURITY SILICON USING MULTIPLE PRECURSORS

(75) Inventors: Antonio Cicero, Roma (IT); Domenico Di Mola, Roma (IT); Rosario Mario Napolitano Melintenda, Roma (IT); Igor M. Ulanov, Roma (IT)

Correspondence Address: KNOBBE MARTENS OLSON & BEAR LLP, 2040 MAIN STREET, FOURTEENTH FLOOR, IRVINE, CA, 92614, US

(73) Assignee: SOLARIA TECNOLOGIE S.R.L., Roma (IT)

(21) Appl. No.: 12/444,157

(22) PCT Filed: Sep. 27, 2007
(86) PCT No.: PCT/IT2007/000675

§ 371 Date: May 10, 2010

(30) Foreign Application Priority Data
Oct. 2, 2006 (IT) RM2006A000521

(51) Int. Cl. C01B 33/021; B01J 19/08

(52) U.S. Cl. 423/349; 422/186

(57) ABSTRACT

Using a transformer coupled plasma reactor, it is possible to achieve continuous production of plasma which decomposes precursors containing silicon in order to produce pure silicon powder. The pure silicon powder is then gathered, treated and used to produce ingots of silicon for use in photovoltaics or semiconductors.

This invention concerns a procedure for the production of high-purity silicon using multiple precursors.

More particularly, it provides for the use of a plasma reactor in which precursors containing silicon are decomposed in order to produce pure silicon powder. The silicon powder is then collected, treated and used for the production of high-purity silicon ingots which can be used in photovoltaics or semi-conductors.

As can be seen from the state of techniques for the production of pure silicon, modern processes are based on the preparation of precursors that can be purified by distillation and later decomposed in order to provide pure silicon.

The precursors are normally produced by passing Hydrochloric acid (HCl) over a bed of metallurgic silicon (MSi) grains in order to obtain trichlorosilane with the formula:

MSi+3HCl═SiHCl₃+H₂

Yields from this process are of around 80-90%; the remaining is mainly made up of SiCl₄ which must be removed. As it is an exothermic procedure it must be cooled or the yield is noticeably lower, as various unwanted chlorosilanes are produced.

Many impurities combine with chlorine to form composites that must be removed. Distillation therefore has the double purpose of removing impurities and separating the trichlorosilane from other chlorosilanes.

The most common method is the so-called Siemens method, in which Trichlorosilane, after various distillations, is introduced into a chamber (reactor) where it decomposes and is deposited on a silicon filament at around 1100° C.

2SiHCl4=Si+2HCl+SiCl4

The thus produced silicon is removed from the reactor when it reaches a weight of around 5 kg. The purity of this silicon can vary between 99.9999% and 99.999999% according to its use. The purity is principally determined by the degree of distillation.

The SiCl₄ produced by the reaction is partly recycled using catalytic processes and partly converted into silica.

This procedure is fully described in Handbook of Semi-conductor Technology (1990), Noyes Publications, Park Ridge, N.J. USA pp 2-16.

The energetic costs for producing pure silicon with this method are extremely high, over 200 kW/h per kilogram of silicon produced. The investment required for one of these plants is equally high. Furthermore, the process is not a continuous one and the reactor must be opened periodically in order to remove the purified silicon.

The main drawbacks and disadvantages of the above known method are above all:
the high cost in energy;
the high cost of the plant;
the non-continuous flux;
the difficulty in recycling undesired precursors;
the need to have the inside of the reactor made up of special materials that resist to HCl;
the need to install safety devices and systems in the plant for the protection of personnel;
the need to install environmental protection devices and safeguards in the plant;
the problem of the disposal of toxic non-recyclable products such as HCl, SiCl₄; and
the problem of disposing of silica.

A procedure for the purification of silicon is suggested by the U.S. Pat. No. 6,926,876. This patent provides for the use of silica instead of metallurgical silicon as raw material. The silica is then made to react with hydrofluoric acid (HF) in order to produce SiF₄. After several distillations the SiF₄ decomposes, in the presence of hydrogen, into an inductively coupled plasma from which the pure silicon is obtained.

This procedure too contains several inconvenients, such as the fact that the hydrofluoric acid is extremely dangerous to human health. Even a minimum contact can cause bone damage and is potentially lethal. Thus, considerable safety measures against accidents are required, with a consequent increase in costs.

Furthermore, corrosion within the system is difficult to avoid and indeed the author of the above-mentioned US patent takes care in its description to note that the use of fluorine necessitates the implementation of means to resist to corrosion.

A further inconvenience is the fact that the decomposition reaction takes place within the inductively coupled plasma. This means that the plasma coupling is interrupted by the silicon as the latter is deposited on the surface of the chamber, necessitating frequent cleaning of the reactor.

Finally, an alternative reaction to the use of SiF₄ is also suggested. This consists in using SiCl₄, that is obtained using HCl with the formula SiO₂+HCl=H₂O+SiCl₄. This reaction has probably not been proven as the contemporary presence of H₂O and SiCl₄ occurs in a very violent reaction that produces SiO₂ and HCl which is the opposite to the reaction that is sought.

According to this invention, the procedure for the purification of silicon takes place by means of the following phases:

### Production of Precursors Through a Fluidized Bed of Metallurgical Silicon

The fluidized bed consists of a container of metallurgical silicon grains through which hydrochloric acid is passed in order to produce any precursor in the form of a chlorosilane, such as SiCl₄, SiHCl₃, SiH₂Cl₂ etc. Unlike traditional methods, this system does not require particularly accurate temperature control as any chlorosilane can be produced and not only SiHCl₃.

### Distillation to Remove Impurities

Distillation is only required in order to remove impurities such as BCl₃, CCl₄, Al₃Cl₄ etc. and not for the separation of chlorosilanes as is the case with traditional procedures. The distillation plant is therefore greatly simplified.

### Stockpiling of Precursors

Stockpiling of the various precursors is achieved with existing types of containers and pumps.

The apparatus required for carrying out the procedure according to the invention is illustrated in the accompanying drawings, in which:

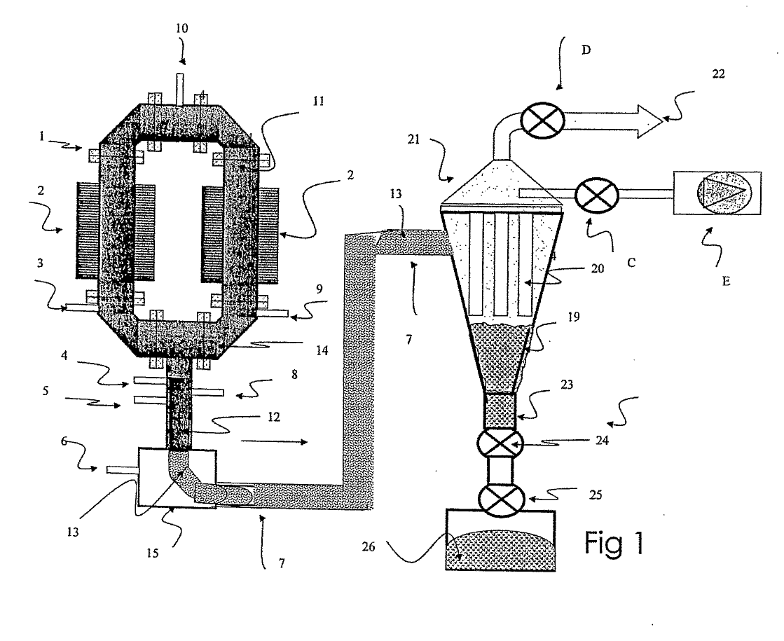

FIG. 1 shows an overall schematic view of the plasma reactor operating together with the reaction chamber in the form preferred by this invention;

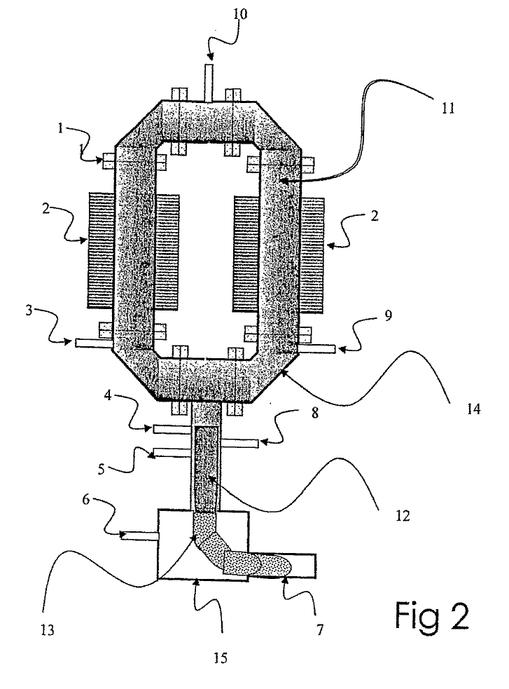

FIG. 2 shows a detailed view of the transformer plasma generator in the manner envisaged by this invention;

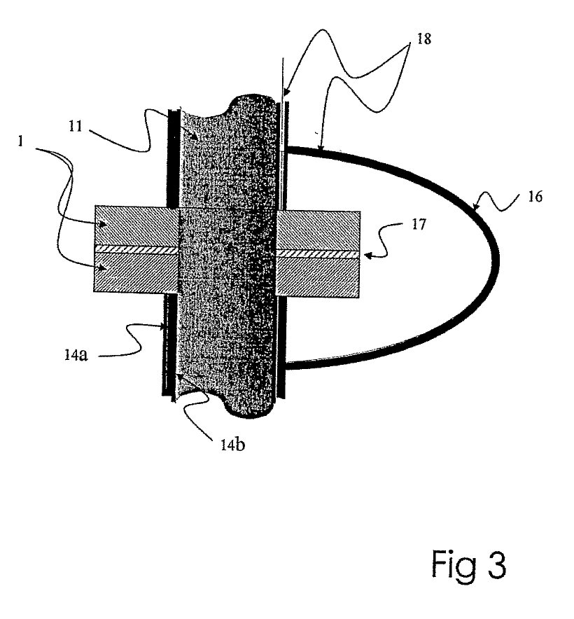

FIG. 3 shows a partial view of the flange joints of the reactor in FIG. 2;

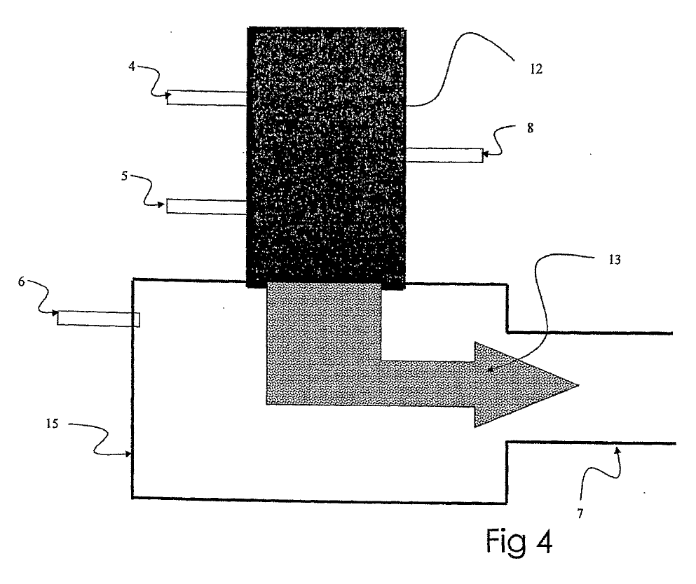

FIG. 4 shows a view of the reaction chamber envisaged by this invention;

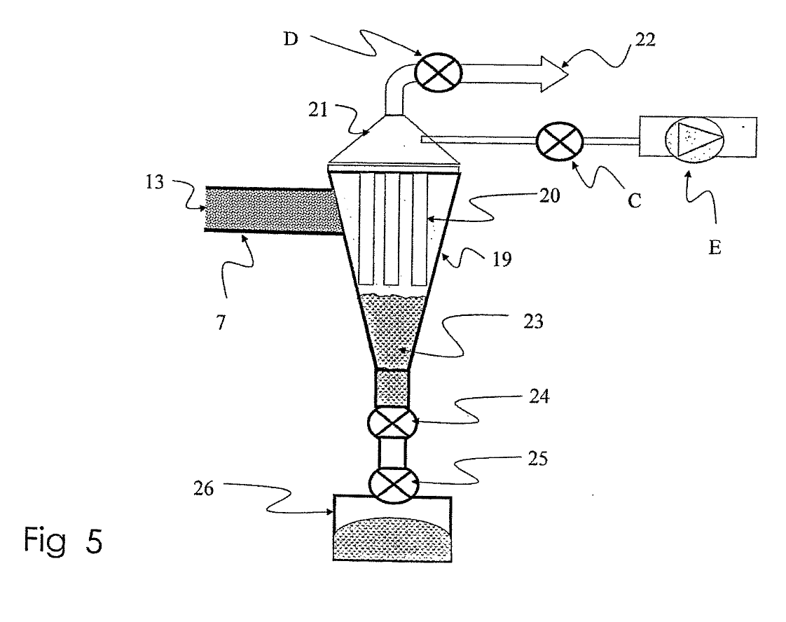

FIG. 5 shows a view of the chamber containing the separation filter for the silicon and reaction gases;

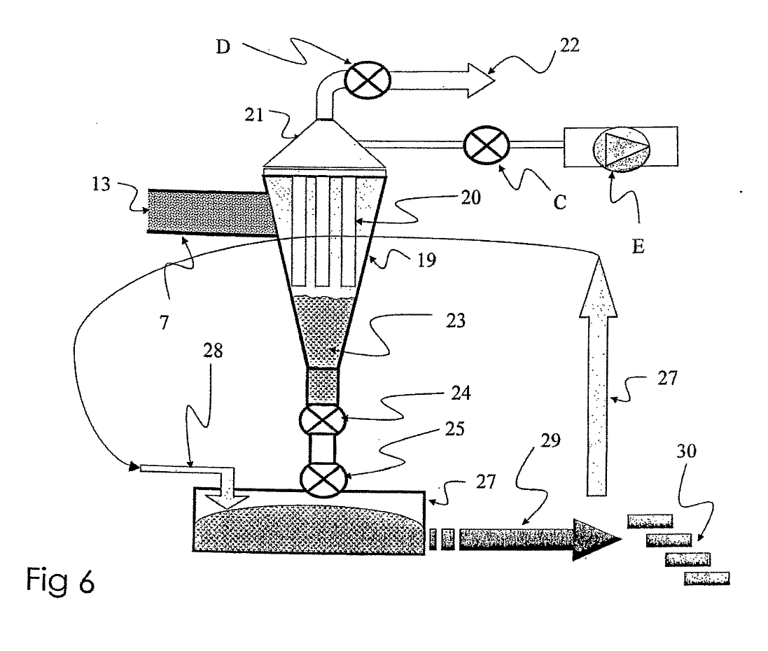

FIG. 6 shows an explanatory view of the final phase of the procedure at the moment of the production of compacted silicon ingots.

This invention requires the use of a plasma generator of a type shown in its entirety in FIG. 1.

This plasma generator produces plasma at atmospheric pressure and enables the use of a reaction chamber that is separated from the one in which the plasma is generated. Once turned on, the generator can therefore produce plasma for the silicon-producing reaction continuously and in such a way that the products of the reaction do not influence its functioning.

Referring to the drawings, and in particular FIGS. 2 and 3, the plasma chamber and its start-up process are described.

According to the invention, a ring 11 is made up of a stainless steel jacket 14,a,b in which cooling water 16, 18 circulates. The jacket is formed by several parts coupled by flanges 1 and an insulator 17. The insulator 17 prevents a possible short circuit outside the plasma due to the steel parts of the jacket.

Plasma is generated by the electromagnetic coupling of the transformer, whose primary is composed of a copper coil over a ferrite core 2. The secondary is composed of the argon contained in the ring 11. The argon is adducted into the ring through the inlet 10 visible in FIG. 1.

In a preferred embodiment, the working frequency of the transformer-ring system is between 50 and 400 KHz.

Referring to FIGS. 5 and 6, the environment is held in depression by the pump E in FIG. 5, connected to the apparatus through valve C visible in FIGS. 5 and 6. The working pressure in this starting phase is less than 500 mTorr. The exaust valve D shown is closed. In such conditions the argon ionizes forming a plasma which is distributed throughout the entire volume of the ring (ignited plasma). After ignition of the plasma, vacuum valve C is closed. The argon pressure rises to reach atmospheric pressure, though the plasma remains ignited. Once atmospheric pressure is achieved inside the apparatus, exaust valve D opens. A continuous generator of plasma available in the reaction chamber 12 of FIG. 2 has therefore been obtained.

When the plasma is ignited, hydrogen is introduced at inlets 3, 9 of FIG. 2 and then heated and made monoatomic by the argon plasma in such quantities that it does not extinguish the plasma itself.

Too great amounts of hydrogen in the volume occupied by the argon plasma would, in fact, create a contiuous hydrogen plasma that would short circuit the argon plasma and could cause it to be extinguished. The argon and hydrogen plasma fills the decomposition chamber 12 placed at the base of the ring. Additional hydrogen, required for the following reaction, is introduced into the chamber through inlet 4.

The quantity of hydrogen, expressed in moles, is more than ten times greater that that of the precursors. Precursors such as SiCl₄, SiHCl₃ or others, are introduced into the chamber through inlets 5 or 8. There is preferably more than one such inlets 5,8 so that the chamber can operate simultaneously with more than one precursor introduced in mixture or separately. For example, precursors such as SiCl₄ split themselves when in contact with the plasma, releasing silicon and forming with the hydrogen HCl and chlorosilanes.

The silicon is in the form of a powder and precipitates into the cooling chamber 15 through gravity and the force of the gases. Cold argon is introduced into the cooling chamber through inlet 6, which drives the silicon into the body of the filter 19 in FIG. 5, where the separation between gas and silicon 23 takes place. Finally, the silicon is gathered in container 26.

Valves 24 and 25 in FIG. 5 are periodically closed and container 26 which has been filled is emptied.

FIG. 6 shows a different embodiment which renders the process a continuous one. In this embodiment, silicon tetrachloride SiCl₄ is introduced in liquid form 28 into the collection container 27 in such a way as it forms a semi-liquid paste (slurry). The slurry is easily transported by means of a pump that can send it to a compactor 29 shown in FIG. 6.

Silicon ingots 30 are formed in compactor 29. The liquid tetrachloride extracted from the slurry by the compactor is sent to a recycling system.

This invention has been described with reference to the working method currently preferred, which should be understood as being merely illustrative and not limiting.

### List of Components and Illustrated Parts

1 Flange
2 Ferrite and primary feed transformer
3 Hydrogen inlet
4 Auxilliary hydrogen inlet
5 Precursors inlet
6 Cooling gas inlet
7 Outlet collector
8 Auxilliary precursors inlet
9 Auxilliary inlet
10 Inert gas inlet
11 Plasma
12 Precursors decomposition chamber
13 Flow of Silicon powder and gas, including reaction gas
14a External wall of plasma container tube
14b Internal wall of plasma container tube
15 Cooling chamber
16 Cooling liquid pipe
17 Electrical insulator
18 Cooling liquid
19 Filter body
20 Filtering element
21 Recycled gas collector
22 Outlet of gas for recycling and or disposal
23 Silicon powder
24 Stop valve for discharge of Silicon powder
25 Stop valve container of Silicon to be removed
26 Silicon powder container
27 Slurry container
28 Inlet for liquid to form slurries
29 Compacting pump
30 Compacted Silicon ingots

1. Method for the production of high quality silicon using multiple precursors wherein the chlorosilane precursors are prepared according to one or more of the following reactions:
Si+3HCl→SiHCl₃+H₂
Si+4HCl→SiCl₄+2H₂
2Si+4HCl→2SiH₂Cl₂
said precursors being introduced into a chamber in order to be decomposed with the aim of obtaining high quality silicon in an elementary phase.

2. The method of claim 1, wherein the precursor decomposition chamber is a plasma reaction chamber.

3. The method of claim 2, wherein at least one noble gas is also introduced into the plasma chamber where the precursors are introduced.

4. The method of claim 3, wherein said noble gas is argon.

5. The method of claim 1, wherein the reaction parameters are chosen so as to lead to the formation of powders possibly associated with microspheres containing components of the reaction mixture.

6. The method of claim 5, wherein the powders undergo a procedure of compacting while at the same time extracting undesired components unconnected with the final product of elementary silicon.

7. The method of claim 6, wherein part or all of the said undesired components present in the powders before compacting are at least in part recycled in the production method.

8. The method of claim 7, wherein the components to be recycled undergo purification for the removal of undesired components.

9. The method of claim 5, wherein the powders are compacted in furnaces to be subjected to fusion and treatment for the production of polycrystalline silicon or silicon monocrystals suitable for use in solar cells and/or semiconductor devices.

10. Apparatus for the production of high quality silicon using multiple precursors and for comprising a transformer-coupled induction plasma reactor which includes a substantially ring-shaped chamber where plasma for induction can be produced; an inlet for introducing reagents into the reaction chamber; a chamber being configured to collect silicon particulate as product and added liquid, the apparatus further comprising valves for sealing the chambers and being configured for the production of polycrystalline silicon rods.

11. Apparatus of claim 10, wherein comprising tubular elements joined together with flanges between which an insulating material is positioned in order to prevent the ring-shaped chamber acting as a short circuit for the transformer.

12. Apparatus of claim 11, wherein said transformer comprises a ferrite core.

13. Apparatus of claim 10, wherein the excitation frequency for the production of plasma is between 50 and 400 KHz.

14. Apparatus of claim 10, wherein the ring-shaped reaction chamber is provided with a jacket for the circulation of coolant.

15. (canceled)
